(19) United States
(12) Patent Application Publication
(10) Pub. No.: US 2026/0060268 A1
(43) Pub. Date: Mar. 5, 2026

(54) STIRRING MECHANISM AND COLD BEVERAGE MAKER

(71) Applicant: Guangzhou Xin'an Trading Co., Ltd., Guangzhou (CN)

(72) Inventor: Quan Zhou, Guangzhou (CN)

(21) Appl. No.: 19/006,323

(22) Filed: Dec. 31, 2024

(30) Foreign Application Priority Data
Aug. 29, 2024 (CN) 202411202973.3
Aug. 29, 2024 (CN) 202422120927.0
Sep. 5, 2024 (CN) 202411243857.6
Sep. 5, 2024 (CN) 202422182973.3

(51) Int. Cl. A23G 9/12

(52) U.S. Cl. CPC A23G 9/12

(57) ABSTRACT

The present disclosure provides a stirring mechanism and a cold beverage maker. The stirring mechanism includes an ice storage container and a spiral stirring paddle, where the ice storage container is provided with an ice outlet; a pair of stirring blades are connected to a central stirring shaft, and surround the central stirring shaft spirally and alternately along a length direction of the central stirring shaft; a tail end of the stirring blade is close to the ice outlet; and with an outer contour close to an inner wall of the ice storage container, the stirring blade is configured to convey material to the ice outlet during rotation. The spiral stirring paddle can solve the problem of easy agglomeration of the material in the local area due to the insufficient stirring and the small stirring range of the existing ice maker.

### CROSS REFERENCE TO RELATED APPLICATIONS

The present application claims the benefit of Chinese Patent Application Nos. 202411243857.6 and 202422182973.3 filed on Sep. 5, 2024, 202411202973.3 and 202422120927.0 filed on Aug. 29, 2024. All the above are hereby incorporated by reference in their entirety.

### TECHNICAL FIELD

The present disclosure relates to the technical field of stirring mechanisms, and in particular to a stirring mechanism and a cold beverage maker.

### BACKGROUND

For the existing cold beverage maker, the storage container is configured to store the ice material, and the refrigeration device is configured to implement refrigeration or insulation for the storage container. When the material is to be conveyed from the storage container, the material is pushed out by a discharge mechanism in the storage container. The material is generally conveyed from the storage container under the driving of a spiral stirring paddle. However, a limited stirring range and a limited shape of the stirring blade of the spiral stirring paddle may result in insufficient stirring and a small stirring range. If not stirred sufficiently, the material is prone to agglomeration in a local area to affect the mouthfeel. Further, the existing spiral stirring paddle cannot convey the material from the storage container once for all, and some material remains at a discharge port. The residual material is removed hardly at the storage temperature. After a long time, the material is accumulated, and cannot be reused. Moreover, the material hinders the conveyance of the subsequent material to affect the discharge efficiency of the storage container.

### SUMMARY

An objective of the present disclosure is to provide a stirring mechanism. The spiral stirring paddle is provided with a pair of stirring blades, and the stirring blades surround the central stirring shaft spirally, so the present disclosure can stir the material in the ice storage container sufficiently during rotation.

The present disclosure further provides a cold beverage maker, including the stirring mechanism.

To achieve the above-mentioned objectives, the present disclosure adopts the following technical solutions:

The present disclosure provides a stirring mechanism, including an ice storage container and a spiral stirring paddle, where
the ice storage container is provided with an ice outlet; and the spiral stirring paddle is rotatably provided in the ice storage container;
the spiral stirring paddle includes a central stirring shaft and a stirring blade; and
a pair of stirring blades are connected to the central stirring shaft, and surround the central stirring shaft spirally and alternately along a length direction of the central stirring shaft; a tail end of the stirring blade is close to the ice outlet; and with an outer contour close to an inner wall of the ice storage container, the stirring blade is configured to convey material to the ice outlet during rotation.

Preferably, the spiral stirring paddle includes a reflow side plate; and
the reflow side plate is provided at the tail end of the stirring blade; an L-shaped reflow groove is formed between the tail end of the stirring blade and the reflow side plate; the L-shaped reflow groove rotates with the stirring blade; and the stirring blade is configured to receive material near the ice outlet in an area of the reflow side plate, and unload the material in an area out of the reflow side plate, such that the material moves away from the ice outlet.

Preferably, the stirring mechanism further includes a refrigeration mechanism;
the ice storage container includes an ice storage housing and an ice discharge cover;
the ice discharge cover is provided on the ice storage housing; the ice storage housing is provided with an ice storage chamber; a refrigerating end of the refrigeration mechanism is attached to an outer sidewall of the ice storage chamber; the ice discharge cover is provided with an ice discharge chamber; the ice storage chamber horizontally communicates with the ice discharge chamber; the ice discharge chamber is provided with the ice outlet; and the spiral stirring paddle is located between the ice storage chamber and the ice discharge chamber; and
the stirring blade at the L-shaped reflow groove extends near the ice outlet to the ice storage chamber.

Preferably, the ice outlet is formed at a lower side of the ice discharge chamber, and located at a horizontal end of the ice storage container; a plurality of grid plates spaced apart from each other are arranged in the ice outlet; and the L-shaped reflow groove rotatably passes through the plurality of grid plates.

Preferably, the refrigerating end of the refrigeration mechanism is provided with a refrigerating tube; and the refrigerating tube surrounds and contacts the outer sidewall of the ice storage chamber.

Preferably, the stirring mechanism further includes a rotating motor; and
an output end of the rotating motor is connected to the spiral stirring paddle; and the rotating motor is configured to drive the spiral stirring paddle to rotate clockwise or counterclockwise, and configured to push the material of the ice storage container to the ice outlet in one rotation direction, and move the material away from the ice outlet through the L-shaped reflow groove in the other rotation direction.

Preferably, the spiral stirring paddle further includes a connecting rib; and
the connecting rib includes one end connected to the central stirring shaft, and the other end connected to an inner ring of the stirring blade; and a plurality of connecting ribs are arranged along the length direction of the central stirring shaft.

Preferably, the spiral stirring paddle further includes a circular stirring base and a reinforcing rib; and
the stirring blade includes one horizontal end connected to the circular stirring base, and the other horizontal end provided with the L-shaped reflow groove; the reinforcing rib includes one end connected to the central stirring shaft, and the other end connected to the circular stirring base; and a plurality of reinforcing ribs surround the circular stirring base.

The present disclosure provides a cold beverage maker, including the stirring mechanism.

Compared with the prior art, any one of the foregoing technical solutions has following beneficial effects:

The spiral stirring paddle is provided with the pair of stirring blades, and the stirring blades surround the central stirring shaft spirally, so the stirring mechanism provided by the present disclosure can stir the material in the ice storage container sufficiently during rotation. This solves the problem of easy agglomeration of the material in the local area due to the insufficient stirring and the small stirring range of the existing ice maker.

### BRIEF DESCRIPTION OF THE DRAWINGS

FIG. 1 is a schematic structural view of a spiral stirring paddle according to an embodiment;

FIG. 2 is a schematic structural view of an ice outlet according to an embodiment;

FIG. 3 is a schematic exploded view of a stirring mechanism according to an embodiment;

FIG. 4 is a schematic sectional view of a stirring mechanism according to an embodiment; and

FIG. 5 is an enlarged view of A in FIG. 4.

In the figures:
1: ice storage container, 2: refrigeration mechanism, 4: spiral stirring paddle, and 5: rotating motor;
11: ice storage housing, and 12: ice discharge cover;
111: ice storage chamber, 121: ice discharge chamber, 122: ice outlet, 123: grid plate, and 21: refrigerating tube; and
41: central stirring shaft, 42: stirring blade, 43: reflow side plate, 44: connecting rib, 45: circular stirring base, 46: reinforcing rib, and 421: L-shaped reflow groove.

### DETAILED DESCRIPTION

The embodiments of the present disclosure are described below in detail. Examples of the embodiments are shown in the drawings. The same or similar numerals represent the same or similar elements or elements having the same or similar functions throughout the specification. The embodiments described below with reference to the accompanying drawings are exemplary. These embodiments are merely used to explain the present disclosure, and should not be construed as a limitation to the present disclosure.

In the description of this application, it should be noted that orientation or position relationships indicated by terms such as “central”, “longitudinal”, “transverse”, “length”, “width”, “thickness”, “upper”, “lower”, “left”, “right”, “front”, “rear”, “vertical”, “horizontal”, “top”, “bottom”, “inner”, “outer”, “inside”, “outside”, “inner end”, “outer end”, “axial”, “radial”, and “circumferential” are orientation or position relationships based on the accompanying drawings, and are to facilitate a simple description of the technical solutions of this application only, rather than to indicate or imply that the mentioned apparatus or element must have the specific orientation or be constructed and operated in the specific orientation. Therefore, these terms cannot be construed as a limitation to this application. In addition, features defined with “first” and “second” may explicitly or implicitly include one or more of the features, and are intended to distinguish descriptive features without an order of sequences and an order of importance. In the description of the present disclosure, unless otherwise specified, “a plurality of” means two or more.

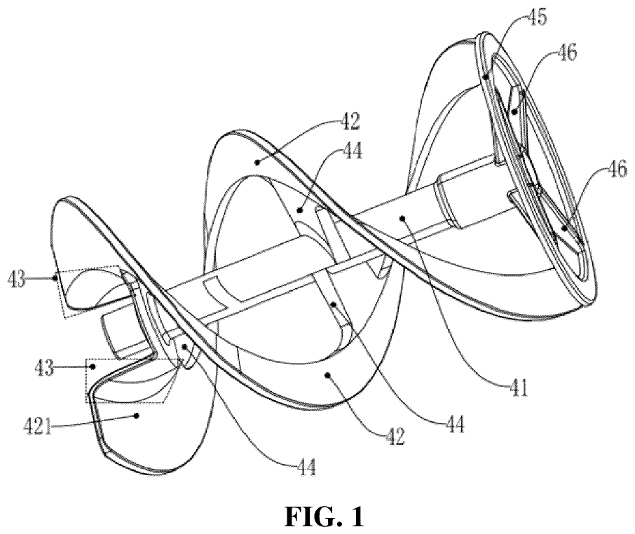

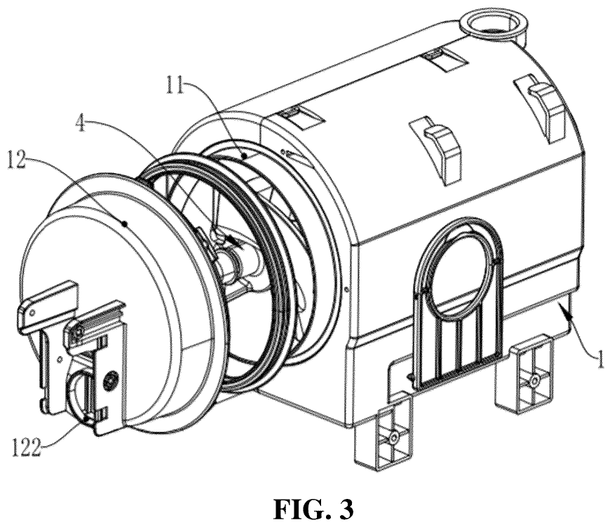

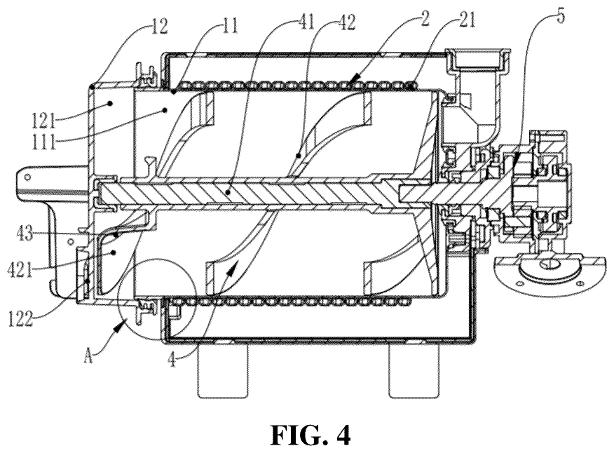

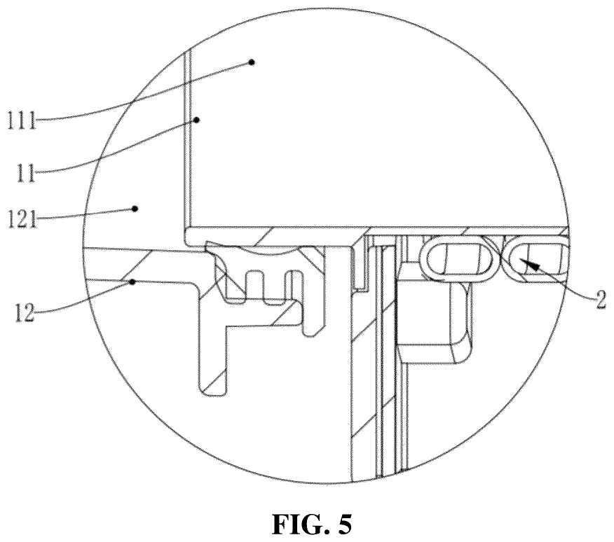

As shown in FIGS. 1-5, a stirring mechanism includes an ice storage container 1 and a spiral stirring paddle 4.

The ice storage container 1 is provided with an ice outlet 122. The spiral stirring paddle 4 is rotatably provided in the ice storage container 1.

The spiral stirring paddle 4 includes a central stirring shaft 41 and a stirring blade 42.

A pair of stirring blades 42 are connected to the central stirring shaft 41, and surround the central stirring shaft 41 spirally and alternately along a length direction of the central stirring shaft 41. A tail end of the stirring blade 42 is close to the ice outlet 122. With an outer contour close to an inner wall of the ice storage container 1, the stirring blade 42 is configured to convey material to the ice outlet 122 during rotation.

The spiral stirring paddle 4 is provided with the pair of stirring blades 42, and the stirring blades 42 surround the central stirring shaft 41 spirally, so the stirring mechanism provided by the present disclosure can stir the material in the ice storage container 1 sufficiently during rotation. This solves the problem of easy agglomeration of the material in the local area due to the insufficient stirring and the small stirring range of the existing ice maker.

Specifically, the ice storage container 1 is a material storage area of the ice maker. The ice storage container 1 can be provided with a heat preservation function as needed, and can also be provided with a refrigeration mechanism 2 as needed. The material is mainly stored in a cold environment as a solidified state. For the spiral stirring paddle 4, the pair of stirring blades 42 are provided on the central stirring shaft 41. The stirring blades 42 extend from one end of the central stirring shaft 41 to the other end of the central stirring shaft 41. The stirring blades 42 are distributed spirally and alternately. That is, while a section of one stirring blade 42 is wound on the central stirring shaft 41, a section of the other stirring blade 42 is wound correspondingly under the central stirring shaft 41. In this way, the pair of stirring blades 42 can surround the central stirring shaft 41 alternately and seamlessly to form an alternately distributed spiral structure. In response to half rotation of the central stirring shaft 41, one stirring blade 42 pushes the material forward by one unit. In response to continuous half rotation of the central stirring shaft 41, the other stirring blade 42 pushes the material forward by one unit. The pair of stirring blades 42 can push the material forward seamlessly, thereby shortening retention time of the material in movement. Since the material is not stayed at a position, the material in the ice storage container 1 is not prone to agglomeration, and can be stirred sufficiently. Meanwhile, since the outer contour of the stirring blade 42 is close to the inner wall of the ice storage container 1, the outermost side of the stirring blade 42 can be close to the inner wall of the ice storage container 1, and the stirring blade 42 has a large stirring range, and can stir the material sufficiently. The stirring blade 42 is distributed spirally, so the stirring blade 42 in rotation pushes the material to the ice outlet 122, and the material can be conveyed from the ice outlet 122. The material can further be dispersed when being pushed. Therefore, the stirring mechanism solves the problem of easy agglomeration of the material in the local area due to the insufficient stirring and the small stirring range of the existing ice maker.

Preferably, the spiral stirring paddle 4 includes a reflow side plate 43.

The reflow side plate 43 is provided at the tail end of the stirring blade 42. An L-shaped reflow groove 421 is formed between the tail end of the stirring blade 42 and the reflow side plate 43. The L-shaped reflow groove 421 rotates with the stirring blade 42. The stirring blade 42 is configured to receive material near the ice outlet 122 in an area of the reflow side plate 43, and unload the material in an area out of the reflow side plate 43, such that the material moves away from the ice outlet 122.

In addition to stirring the material and conveying the material, the spiral stirring paddle 4 can further separate the material at the ice outlet 122 from the ice outlet 122, so as to prevent blockage of the material at the ice outlet 122. Specially, the stirring blade 42 spirally surrounds the central stirring shaft 41. The stirring blade 42 may be connected to the central stirring shaft 41 at a middle, may also be connected to the central stirring shaft 41 at an end, and may further be connected to the central stirring shaft at other positions. Due to spiral surrounding of the stirring blade 42, two ends of the stirring blade 42 extend in a cambered manner. The reflow side plate 43 is provided at the tail end of the stirring blade 42. The L-shaped reflow groove 421 is formed between the tail end of the stirring blade and the reflow side plate. The stirring blade 42 in rotation drives the L-shaped reflow groove 421 to rotate cyclically. Between the stirring blade 42 and the reflow side plate 43, the L-shaped reflow groove 421 in rotation scrapes an inner wall of the ice discharge chamber 121 near the ice outlet 122, thereby receiving scraped material between the stirring blade 42 and the reflow side plate 43. The material rotates with the L-shaped reflow groove 421. Since the tail end of the stirring blade 42 is cambered, the reflow side plate 43 stops the material at a low position, and the material does not fall off easily in the area of the reflow side plate 43. When the reflow side plate 43 rotates to a high position, the space under the stirring blade 42 is hollow, the material is not supported by the reflow side plate 43, and the material is unloaded in the area out of the reflow side plate 43 and separated from the ice outlet 122. The material neither remains easily at the ice outlet 122, nor is accumulated at the ice outlet 122. This reduces influences of the accumulated material on the subsequent discharge, and prevents the material at the ice outlet 122 from being frozen into the ice. Only with the single drive source, the central stirring shaft 41 is driven to rotate, thereby realizing the material stirring function, the material conveying function, and the anti-accumulation function at the ice outlet 122.

Preferably, the stirring mechanism further includes a refrigeration mechanism 2.

The ice storage container 1 includes an ice storage housing 11 and an ice discharge cover 12.

The ice discharge cover 12 is provided on the ice storage housing 11. The ice storage housing 11 is provided with an ice storage chamber 111. A refrigerating end of the refrigeration mechanism 2 is attached to an outer sidewall of the ice storage chamber 111. The ice discharge cover 12 is provided with an ice discharge chamber 121. The ice storage chamber 111 horizontally communicates with the ice discharge chamber 121. The ice discharge chamber 121 is provided with the ice outlet 122. The spiral stirring paddle 4 is located between the ice storage chamber 111 and the ice discharge chamber 121.

The stirring blade 42 at the L-shaped reflow groove 421 extends near the ice outlet 122 to the ice storage chamber 111.

In an optimal embodiment, the stirring blade 42 extends near the ice outlet 122 to the ice storage chamber 111. That is, in the area out of the reflow side plate 43, the material is conveyed to the ice storage chamber 111 in rotation of the ice storage chamber 111. In this way, the material does not fall off in the area of the reflow side plate 43, namely in the ice discharge chamber 121. When the reflow side plate 43 extends to the ice storage chamber 111 (such as an opening of the ice storage chamber 111), the reflow side plate 43 does not support the material after rotating to the ice storage chamber 111, and the material falls onto the opening of the ice storage chamber 111. Therefore, the material is quickly reflowed from the ice outlet 122 to the ice storage chamber 111, and the material is not accumulated in the ice discharge chamber 121. The refrigerating end of the refrigeration mechanism 2 is attached to the outer sidewall of the ice storage chamber 111. An outer side of the ice discharge chamber 121 is not provided with the refrigeration mechanism 2, but mainly configured to contact air or other structures. The air surrounds an outer sidewall of the ice discharge chamber 121, such that the inside of the ice discharge chamber 121 can be heated through the outer sidewall of the ice discharge chamber 121, and the temperature of the ice discharge chamber 121 rises. Since the temperature of the ice storage chamber 111 is lower than the temperature of the ice discharge chamber 121, the material has higher fluidity in the ice discharge chamber 121, and can be discharged from the ice outlet 122 more easily, thereby reducing a residue of the material at the ice outlet 122.

Preferably, the ice outlet 122 is formed at a lower side of the ice discharge chamber 121, and located at a horizontal end of the ice storage container 1. A plurality of grid plates 123 spaced apart from each other are arranged in the ice outlet 122. The L-shaped reflow groove 421 rotatably passes through the plurality of grid plates 123.

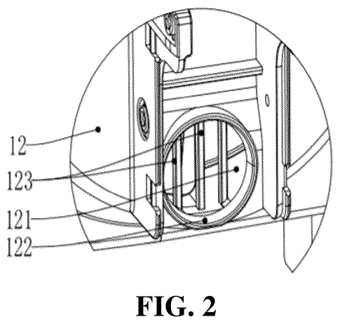

As shown in FIG. 2, a plurality of grid plates 123 are arranged in the ice outlet 122, which is equivalent to that the ice outlet is spaced apart by the grid plates 123 to form a plurality of branch ports. Each branch port can convey the material independently. This can prevent the accumulation of the material at the single branch port. Meanwhile, the L-shaped reflow groove 421 rotatably passes through the plurality of grid plates 123, such that the material at each branch port can be scraped, and reflowed to the ice storage chamber 111. Particularly for the spiral stirring paddle 4 with dual stirring blades 42 in the present disclosure, the two stirring blades 42 scrape the ice outlet 122 alternately, and can scrape the plurality of branch ports in the ice outlet 122 seamlessly. Therefore, the material is not accumulated easily at the ice outlet 122, and is removed at high efficiency.

Preferably, the refrigerating end of the refrigeration mechanism 2 is provided with a refrigerating tube 21. The refrigerating tube 21 surrounds and contacts the outer sidewall of the ice storage chamber 111.

A refrigerating medium may be charged to the refrigerating tube 21. The heat in the ice storage chamber 111 is taken away by the refrigerating medium of the refrigerating tube 21, thereby keeping the ice storage chamber 111 at a low temperature.

Preferably, the stirring mechanism further includes a rotating motor 5.

An output end of the rotating motor 5 is connected to the spiral stirring paddle 4. The rotating motor 5 is configured to drive the spiral stirring paddle 4 to rotate clockwise or counterclockwise, and configured to push the material of the ice storage container 1 to the ice outlet 122 in one rotation direction, and move the material away from the ice outlet 122 through the L-shaped reflow groove 421 in the other rotation direction.

The rotating motor 5 in the present disclosure is the known motor. The rotating motor 5 has the adjustable rotation direction, and rotates clockwise or counterclockwise. As shown in the figure, in response to counterclockwise rotation of the spiral stirring paddle 4, the stirring blade 42 pushes the material of the ice storage container 1 to the ice outlet 122. As long as the spiral stirring paddle 4 rotates counterclockwise, the material can be pushed out by the spiral stirring blade 42. Upon completion of discharge of the ice storage container 1, the rotation direction of the rotating motor 5 can be switched, and the spiral stirring paddle 4 is switched to rotate clockwise. By scraping the inner wall of the ice storage container 1 near the ice outlet 122 through the L-shaped reflow groove 421, the material remaining near the ice outlet 122 is reflowed to move away from the ice outlet 122.

Preferably, the spiral stirring paddle 4 further includes a connecting rib 44.

The connecting rib 44 includes one end connected to the central stirring shaft 41, and the other end connected to an inner ring of the stirring blade 42. A plurality of connecting ribs 44 are arranged along the length direction of the central stirring shaft 41.

There are a plurality of connecting ribs 44. This is mainly intended to connect different horizontal positions of the stirring blade 42 to the central stirring shaft 41, and can make the central stirring shaft 41 and the stirring blade 42 connected more firmly. The stirring blade 42 does not deform or shake easily in rotation to improve a mechanical strength of the stirring blade 42. Meanwhile, the stirring blade 42 is distributed spirally. The stirring blade 42 includes the inner ring and an outer ring. The inner ring is mainly connected to the connecting rib 44. The area out of the inner ring is the main stirring range. The connecting rib 44 connected to the inner ring may further be configured to stir the material on the inner ring of the stirring blade 42, which can make up the blind stirring area of the stirring blade 42.

Preferably, the spiral stirring paddle 4 further includes a circular stirring base 45 and a reinforcing rib 46.

The stirring blade 42 includes one horizontal end connected to the circular stirring base 45, and the other horizontal end provided with the L-shaped reflow groove 421. The reinforcing rib 46 includes one end connected to the central stirring shaft 41, and the other end connected to the circular stirring base 45. A plurality of reinforcing ribs 46 surround the circular stirring base 45.

The reinforcing rib 46 is provided at one end of the stirring blade 42. Through the reinforcing rib 46, the circular stirring base 45 is connected to the central stirring shaft 41. The end of the central stirring shaft 41 is connected to the circular stirring base 45 through the reinforcing rib 46. There are a plurality of reinforcing ribs 46 that surround the circular stirring base. This can make the circular stirring base 45 and the central stirring shaft 41 connected more firmly. Meanwhile, the reinforcing rib 46 can stir the material at the end of the stirring blade 42, which can make up the blind stirring area of the stirring blade 42. Moreover, the end of the stirring blade 42 is connected to the circular stirring base 45, and the connecting rib 44 is connected to the stirring blade 42, such that the connection stability between the stirring blade 42 and the central stirring shaft 41 is further improved.

The present disclosure provides a cold beverage maker, including the stirring mechanism in any of the above embodiments.

Although the embodiments of the present disclosure have been illustrated, it should be understood that those of ordinary skill in the art may still make various changes, modifications, replacements, and variations to the foregoing embodiments without departing from the principle and tenet of the present disclosure, and the scope of the present disclosure is defined by the claims and equivalents thereof.

1. A stirring mechanism, comprising an ice storage container and a spiral stirring paddle, wherein
the ice storage container is provided with an ice outlet; and the spiral stirring paddle is rotatably provided in the ice storage container;
the spiral stirring paddle comprises a central stirring shaft and a stirring blade; and
a pair of stirring blades are connected to the central stirring shaft, and surround the central stirring shaft spirally and alternately along a length direction of the central stirring shaft; a tail end of the stirring blade is close to the ice outlet; and with an outer contour close to an inner wall of the ice storage container, the stirring blade is configured to convey material to the ice outlet during rotation.

2. The stirring mechanism according to claim 1, wherein the spiral stirring paddle comprises a reflow side plate; and
the reflow side plate is provided at the tail end of the stirring blade; an L-shaped reflow groove is formed between the tail end of the stirring blade and the reflow side plate; the L-shaped reflow groove rotates with the stirring blade; and the stirring blade is configured to receive material near the ice outlet in an area of the reflow side plate, and unload the material in an area out of the reflow side plate, such that the material moves away from the ice outlet.

3. The stirring mechanism according to claim 2, further comprising a refrigeration mechanism, wherein
the ice storage container comprises an ice storage housing and an ice discharge cover;
the ice discharge cover is provided on the ice storage housing; the ice storage housing is provided with an ice storage chamber; a refrigerating end of the refrigeration mechanism is attached to an outer sidewall of the ice storage chamber; the ice discharge cover is provided with an ice discharge chamber; the ice storage chamber horizontally communicates with the ice discharge chamber; the ice discharge chamber is provided with the ice outlet; and the spiral stirring paddle is located between the ice storage chamber and the ice discharge chamber; and
the stirring blade at the L-shaped reflow groove extends near the ice outlet to the ice storage chamber.

4. The stirring mechanism according to claim 3, wherein the ice outlet is formed at a lower side of the ice discharge chamber, and located at a horizontal end of the ice storage container; a plurality of grid plates spaced apart from each other are arranged in the ice outlet; and the L-shaped reflow groove rotatably passes through the plurality of grid plates.

5. The stirring mechanism according to claim 4, wherein the refrigerating end of the refrigeration mechanism is provided with a refrigerating tube; and the refrigerating tube surrounds and contacts the outer sidewall of the ice storage chamber.

6. The stirring mechanism according to claim 2, further comprising a rotating motor, wherein
an output end of the rotating motor is connected to the spiral stirring paddle; and the rotating motor is configured to drive the spiral stirring paddle to rotate clockwise or counterclockwise, and configured to push the material of the ice storage container to the ice outlet in one rotation direction, and move the material away from the ice outlet through the L-shaped reflow groove in the other rotation direction.

7. The stirring mechanism according to claim 2, wherein the spiral stirring paddle further comprises a connecting rib; and
the connecting rib comprises one end connected to the central stirring shaft, and the other end connected to an inner ring of the stirring blade; and a plurality of connecting ribs are arranged along the length direction of the central stirring shaft.

8. The stirring mechanism according to claim 7, wherein the spiral stirring paddle further comprises a circular stirring base and a reinforcing rib; and
the stirring blade comprises one horizontal end connected to the circular stirring base, and the other horizontal end provided with the L-shaped reflow groove; the reinforcing rib comprises one end connected to the central stirring shaft, and the other end connected to the circular stirring base; and a plurality of reinforcing ribs surround the circular stirring base.

9. A cold beverage maker, comprising the stirring mechanism according to claim 1.
